(19) United States
(12) Patent Application Publication
(10) Pub. No.: US 2009/0213139 A1
(43) Pub. Date: Aug. 27, 2009

(54) System and a method for providing information to a user as object moving over a display

(76) Inventor: Knud Funch, Thisted (DK)

Correspondence Address: HARNESS, DICKEY & PIERCE, P.L.C., P.O. BOX 8910, RESTON, VA, 20195, US

(21) Appl. No.: 12/320,838

(22) Filed: Feb. 5, 2009

Related U.S. Application Data
(60) Provisional application No. 61/006,874, filed on Feb. 5, 2008.

(51) Int. Cl. G09G 5/00

(52) U.S. Cl. 345/619

(57) ABSTRACT

A number of events are available to a user, and images relating to a group thereof are provided as images moving across a display. Depending on the frequency of use, source, relevance or availability thereof, the images may follow different paths having different directions over the display.

The present invention relates to a method and a system for user friendly access to media information and presentation of the same, e.g. access and present information related to music files, and play the music.

The huge amount of available digital information can be reduced into groups of relevant information that's applicable and useful and manageable by the user:
A Shop level may be defined, containing millions of objects available to the user. The Shop includes the files residing on e.g. Internet servers. This number of events may be reduced to a manageable subset using a search function.
A Browser level may be defined, typically containing thousands of objects readily available to the user. Such files may reside on the user's own resources, like servers and/or PCs, and/or Laptops, and/or media players.
A Favorites level may be defined, typically containing hundreds of user selected media files. Such files may reside on the user's own resources like servers and/or PCs, and/or Laptops, and/or media players and may be files often or recently accessed.
An appetizer level may be defined, containing tens of media files, the appearance of which is triggered automatically by predefined events.

In this manner, different modes may also be defined in a media centre:
An appetizer mode where the media centre presents events for the user to choose between,
A player mode, where a selected event is provided, and
A browser mode, where the user actively browses in the available events.

The present invention relates primarily to the appetizer mode, where different events are presented to the user.

In a first aspect, the invention relates to a method of presenting visual information relating to one or more available events to a user, the method comprising:
1. providing a display or monitor having a display/monitor surface,
2. providing, for each of a first group of available events, an image relating thereto,
3. displaying the images of one or more events of the first group on the display/monitor, each image moving along a predetermined path having a first general direction over the display/monitor surface,
4. providing information relating to a second group of events, the information comprising an image relating to each event of the second group, and
5. displaying the images of one or more events of the second group on the display/monitor, each image moving along a predetermined path having a second general direction over the display/monitor surface, the second general direction being different from the first general direction.

In the present context, visual information may be any type of visual information which may remind or inform a person of the event(s) to which it relates. A wide variety of possibilities exists of providing such information, as “relating to” should be interpreted widely.

When the event(s) is/are audio tracks, the visual information may be the cover of an album on which the track(s) is/are provided. A collection of audio tracks relating to a movie may be represented by a poster or other image relating to the movie. Alternatively or in addition, an image of the artist(s) or his/her/their logo or other symbol, or an event, person, thing, or the like which may remind the user of or indicate to the user which track(s) the visual information relate(s) to.

The same normally is the situation when the events are movies or videos, which are also normally provided with a poster or image.

In the situation where an event is a radio/TV channel, radio/TV program or the like, the logo thereof, the sign thereof, or an image of a person or other element representative thereof may be used as the visual information.

For images/pictures or the like, the actual picture/image may be used as the visual information. If multiple images/pictures are grouped as a single event, such as all pictures from a holiday, the user may him/herself either select one of the images/pictures as a representative image/picture, or a combination of one or more of the images/pictures may be provided and used as the visual information.

Naturally, the same visual information may relate to a group of events, such as the cover of an album may relate to all tracks thereof.

In the present context, a display or monitor may be any type of display or monitor, such as a flat screen monitor, a CRT, a LED/LCD/OLED or the like monitor. The display may be a stand-alone display/monitor or may form part of a system holding or storing the events and which may also be able to provide events to the user.

Normally, the images relating to the events are provided with the events, such as when the cover image of an album is downloaded together with the tracks of the album. Alternatively, the user may him/herself provide or define this information.

As to the available events, these may be available to the user or the system in a variety of manners. Some events may be the user's property and may be available from a central storage or via portable storage elements (CDs/CD-ROMs/DVDs/hard discs/podcast/USB-keys/memory cards or the like). Other events may be available from more remote sources, such as other computers, via a network, such as the WWW and/or LANs, WANs or the like. Further events may be available for purchase, such as for download via the WWW from external suppliers or servers.

Visual information may be provided for all such events or for a subset thereof. This subset may be determined in any manner such as on the basis of a search provided on the basis of suitable search strategies. Such strategies may focus on the user's preferred artists, genres, types of events, or any other parameter(s) available from the respective sources and on the basis of which a search may be made.

When displaying the images of the selected event(s) on the display/monitor, each image is moving along a predetermined path over the display/monitor surface. A path may be a straight line or may be curved in any manner. The path may initiate at any position of the display/monitor surface and may end at any position thereof. The display may be virtual 3D, whereby the images may also change in size to emulate a further distance to the viewer.

In the present context, a general direction may be an actual direction or angle of a straight or almost straight line or may be a mean or average direction of a more curved or tortuous path. Two directions are different, if their angles or directions are not identical, and in a preferred embodiment, a reference direction exists in relation to the display/monitor surface compared to which all first general directions have a smaller angle (e.g. to horizontal, vertical or seen clockwise from the reference direction), and all second general directions have a larger angle. In one embodiment, all first directions may be positioned to one side of the reference direction and all second directions to another side thereof, such as if the reference direction was at 45 degrees from vertical, the first directions may be 0-45 degrees from vertical and the second directions 0-45 degrees from horizontal.

Naturally, the path may be determined in advance, and the image may not be allowed to deviate there from. Alternatively, the path or direction of movement may be determined in real time, so that direction changes and the like may be determined for what ever reason.

In one embodiment, the displaying step 3 and/or 5 comprises having images moving along intersecting paths and comprising a step of determining which image is not displayed at the intersection. Thus, it is determined which image prevails over the other when intersecting. Alternatively, the two images may be mixed, if desired.

Alternatively, the images may avoid collisions either by altering their paths when a collision is foreseen, or paths or path patterns may be determined avoiding collision.

Alternatively, the images may collide and bounce from each other to create an entertaining effect.

In one embodiment, the displaying step 3 and/or 5 comprises determining, for at least one event, a size of the image and displaying the image with the determined size. This may be to emulate a 3D-universe where the size indicates the distance to the image or object. It may be decided that all images have the same general shape (such as triangular, square, quadratic or the like) whereby sizes may be used for different purposes. As mentioned above, size is one parameter which may be used for indicating to the user the relevance, source or other parameters of the event.

In one situation, the size of an image is reduced over time. Thus, e.g. if the user does not select the event, it may be reduced in size to take up less space. This reduction in size may be constant (even though the size will be in discrete steps due to the digital nature of monitors) and thus take place also when the image is on the screen or may be performed between the image having exited the screen and being re-introduced. Naturally, the size may be determined in any manner, such as the area of the image, a circumference thereof, a dimension thereof or the like.

In one embodiment, step 5 comprises receiving information relating to an event, not forming part of the first group, from an external supplier, the information comprising information relating to a new image, step 5 further comprising displaying the new image on the display/monitor along a predetermined path having the second general direction. This event may be a new event not being within the first group and/or to which the user or system has no or has not had access. Thus, external suppliers may provide events, such as podcasts or events offered for sale or download. Such events may be received and provided at any time when they e.g. become available. It may, cf below, be desired to make it clear to the user from what source these events are received, such as from the directions of the pertaining images. It may be desired that the first direction is used only for images from the first group.

In one embodiment, step 4 comprises determining or selecting, from the first group of events, the events of the second group of events, each event of the second group corresponding to a predetermined event. Thus, the events displayed along the first direction may be selected on the basis of e.g. frequency of use or the like, whereas those along the other direction may be selected from other events available to the user, although not provided that often, but which correspond to those provided often. In this respect, similarity or correspondence may be in a number of ways, such as genre, author, artist, beats per minute, or the like. One manner of obtaining this is the so-called More Of The Same (MOTS) routine able to determine, from one audio file, other audio files with similar types of music.

In another embodiment, the method further comprises the step of determining, for at least one event, a relevance thereof and a corresponding parameter of the image and wherein step 3 and/or 5 comprises displaying the image with the determined parameter.

In this respect, the relevance of an event may be determined in a variety of manners. A simple manner is a determination of the number of times the user has experienced the event or a similar event (same artist, genre, or the like), or how long it has been since the user last experienced the event or the similar event.

More complex manners also exist where the user's habits and preferences are determined and compared to the event and maybe even the time of day/week/year, the weather, the person's mood and the like. This is described in detail in the Applicants co-pending application EP1826688.

In another embodiment, the method further comprises the step of determining a source of an event and determining a parameter for the corresponding image based on the determined source, and wherein step 3 and/or 5 comprises displaying the corresponding image with the determined parameter.

The actual parameter of the image may be any parameter visual from the images, such as a frequency at which the image is provided, the path taken, the velocity, tortuosity of the path, the starting point thereof, the direction of the movement, the size of the image, the colour thereof (natural colours or B/W, e.g.), or other visual effects (the intensity of the illumination of the image, blinking image or the like).

In another aspect, the invention relates to a method of presenting visual information relating to one or more available events to a user, the method comprising:
1. providing a display or monitor having a display/monitor surface,
2. providing, for each of a first group of available events, an image relating thereto,
3. determining, for at each event of the first group, an initial size of the corresponding image,
4. displaying the images of one or more events of the first group on the display/monitor, each image moving along a predetermined path over the display/monitor surface,
   wherein step 4 comprises initially displaying the one or more images with the initial sizes, the sizes of the images being reduced over time.

As is mentioned above, the reduction in size may be in order for each event when not selected to take up less space. The reduction may also be used for illustrating relative relevance of illustrated events, the larger an event image, the more often has the event been provided, for example. New images may be provided, which are larger than ones having been displayed for a period of time and which therefore have been reduced in size.

One embodiment may, as is also described above, further comprise the step of determining, for at least one event, a relevance thereof and a corresponding parameter of the image and wherein step 4 comprises displaying the image with the determined parameter.

Also, the method may further comprise the step of receiving information relating to an event from an external supplier, step 4 comprising displaying an image relating to the event on the display/monitor. This event may be new, such as an event to which the system or user has not hitherto had access, such as a newly released song/video, or a newly received image/bitmap or text message.

As mentioned above, two different general directions may be used for illustrating to the user different sources, groups, parameters, or the like.

In addition, the method may further comprise the step of determining a source of an event and determining a parameter for the corresponding image based on the determined source, and wherein step 4 comprises displaying the corresponding image with the determined parameter. This is also described above.

In yet another embodiment, the invention relates to a method of presenting visual information relating to one or more available events to a user, the method comprising:
1. providing a display or monitor having a display/monitor surface,
2. providing, for each of a first group of available events, an image relating thereto,
3. determining, at a point in time, information relating to a first number of events provided to the user at previous points in time and determining, for one or more of the previously provided events, a parameter relating to a number of times the event or similar events has/have been provided,
4. selecting a second number of events from the first number of events, the selection being based on the parameters determined,
5. displaying the images of the second number of events on the display/monitor, each image moving along a predetermined path over the display/monitor surface.

Then, the images displayed may relate to the most recently played or most often played or provided events, as these may be taken as those which the user will desire with the largest probability.

In one embodiment, step 5 comprises having images moving along intersecting paths and comprising a step of determining which image is not displayed at the intersection.

In another embodiment, step 5 comprises determining, for at least one event, a size of the image and displaying the image with the determined size. Then, this size of an image may be reduced over time, as is described further above.

One embodiment further comprises the step of receiving information relating to an event, such as a new event, from an external supplier, step 5 comprising displaying an image relating to the event on the display/monitor.

In another embodiment, step 3 and/or 5 comprises determining, for at least one event, a relevance thereof and a corresponding parameter of the image and wherein the displaying step comprises displaying the image with the determined parameter.

Again, a second direction may be used for providing new, externally fed or corresponding events.

Also, an embodiment relates to a method further comprising the step of determining a source of an event and determining a parameter for the corresponding image based on the determined source, and wherein step 5 comprises displaying the corresponding image with the determined parameter.

In general, one embodiment may further comprise the step of a user identifying an image on the display/monitor and a corresponding event, and then providing the event to the user. This identification may be obtained by the user identifying a position of the image on the display/monitor, such as touching the pertaining position if the display/monitor is a touch screen. Alternatively, a mouse, joy stick or other position identifying element may be used.

Also, the image may be identified by identifying any other parameter of the event or image, such as an identity of an author, artist, composer, actor, title, description of the event/image, or the like. This may be performed orally or via e.g. a keyboard.

The providing of the event naturally will depend on the type of event. The providing of an audio track will be the playing of the track using e.g. speakers which may be in a system also comprising the actual display/monitor or to which the display/monitor is connected.

Also, this may require the purchase or availing of the event, which is a known step.

In one situation, the method further comprises the step of identifying one or more events related to the provided event and displaying on the display/monitor images relating to the identified events. Thus, while providing an event, similar events may be provided, as is known from MOTS (more of the same) engines. Thus, events with the same artist/actor/composer or the like may be identified, or other sound recordings of the same song made by other groups or the like.

In one embodiment, the method further comprises the step of a user identifying an image and a corresponding event, and providing additional information relating to the event to the user while displaying images of other events on the display/monitor. This providing of additional information may be the providing of an enlargement of the image and/or the providing of additional information relevant to or relating to the image or the pertaining event, such as an author, director, actor, composer, title, or the like.

In this situation, the additional information may be provided on the display/monitor, and it may be determined that other images may still move over the display/monitor surface, and it may be decided whether this additional information may be overwritten by the other images or whether the area at which the additional information is provided is not to be used for the other images.

In another aspect, the invention relates to a system for presenting visual information relating to one or more available events to a user, the system comprising:
a display or monitor having a display/monitor surface,
first receiving means for receiving, holding or accessing, for each of a first group of the available events, an image relating thereto,
means for controlling the monitor/display to display the images of the first group on the display/monitor, each image moving along a predetermined path having a first general direction over the display/monitor surface, and
second receiving means for receiving, holding or accessing, for a second group of the available events, an image relating thereto,
   the controlling means being adapted to control the monitor/display to display the images of the second group on the display/monitor, each image of the second group moving along a predetermined path having a second general direction over the display/monitor surface, the second general direction being different from the first general direction.

Naturally, the first and/or second receiving/holding/accessing means may be any means for accessing events which may be stored or available locally or remotely. All of or some of the events may be stored in or on the system, such as in electronics thereof, such as in the form of a RAM, ROM, PROM, EPROM, EEPROM, Flash, disc, card (SD, miniSD, microSD or the like), hard disc or the like or may be one or more CD-ROM/DVD discs, and/or electrical, magnetic, or optical, or the like, storage. Alternatively or in addition all of or some of the events may be available thereto from a number of sources, such as from a near-by or internal storage, a remote storage, via a network of any type, or by being streamed from an external source, such as via the WWW or via airborne signals, such as TV or radio signals. This access and communication is handled by the electronics, which comprises or communicates to or via e.g. one or more networking elements, such as NIC's, network adapters, wireless communication devices, routers, switches, Bluetooth elements, IR communication elements, other computers or servers, thin clients, intra nets, the WWW, WANs, LANs or the like. As mentioned above, the display/monitor may be any type of monitor/display, such as CRT's or flat panel monitors, such as LCD/LED/OLED, laser diode displays or the like.

However, it is presently preferred that the first receiving means are adapted to access events directly or readily available, such as stored locally or remotely, in a swift manner. Compared to that, the second receiving means preferably are then adapted to receive the events of the second group from remote sources, such as the www or other computers and may provide these only once received. In one situation, the first group of events may be said to be owned or licensed by the user, whereas the second group of events are not. The second group of events may be events offered for sale/licensing by external entities or may be newly received events never hitherto offered or displayed to the user and which do not form part of the first group of events. Events of the second group may also be newly received messages, e-mails, text messages, images/pictures, videos or the like, such as received from friends or third parties.

The controlling means may be any type of controller, microchip, microprocessor, DSP, FPGA, hardwired or software controlled, or the like.

Again, a path may be determined before introducing the image on the display/monitor or may be determined along the movement, if desired.

In one embodiment, the controlling means are adapted to have images move along intersecting paths and determine which image is not displayed at the intersection. In another embodiment, non-intersecting paths are used, or images are allowed to bounce of each other, whereby the paths may be determined during the movement to allow such bouncing.

In one embodiment, the controlling means are adapted to determine, for at least one event, a size of the image and controlling the monitor/display to display the image with the determined size. This may be in order to emulate a 3D universe where the size illustrates a distance to the object.

In one situation, the controlling means are adapted to reduce the size of an image over time. This may be performed when the image is not provided on the display or while it is provided.

In one embodiment, the second receiving means are adapted to receive information relating to an event from an external supplier, the controlling means being adapted to control the monitor/display to display an image relating to the event along a predetermined path having the second general direction. Such receiving means may be adapted to receive information from the WWW via a network, LAN, WAN, wireless network, via a cell phone, satellite link or the like.

As described above, the second receiving means may be adapted to select the second group of events from the first group of events, each event of the second group corresponding to a predetermined event. In one situation, the events of the second group are identified from the predetermined event as events corresponding to the predetermined event.

In another embodiment, the system further comprises means for determining a relevance of at least one event as well as a corresponding parameter of the image and forward this parameter to the controlling means which is adapted to have the corresponding image displayed with the determined parameter.

As mentioned above, the relevance may be determined in any of a large number of manners.

In another embodiment, the system further comprises means for determining a source of at least one event and determining a parameter for the corresponding image based on the determined source, and wherein the controlling means is adapted to have the corresponding image displayed with the determined parameter.

As mentioned above, the determined parameter may be a frequency of presenting the image, a particular path, velocity and/or size, colour, or other visual effect of the image.

In another aspect, the invention relates to a system for presenting visual information relating to one or more available events to a user, the system comprising:
a display or monitor having a display/monitor surface,
first means for receiving, holding or accessing, for each of a first group of the available events, an image relating thereto,
means for determining, for at each event of the first group, an initial size of the corresponding image, and
means for controlling the monitor/display to display the images of the first group on the display/monitor so that each image moves along a predetermined path, each image initially has its initial size and the size of each image is reduced in time.

As mentioned above, the size may be used for illustrating a relevance of the event and the reduction be a sign that the event has not been selected or experienced for a period of time.

In one embodiment, the system further comprises means for determining a relevance of at least one event as well as a corresponding parameter of the image and forward this parameter to the controlling means which is adapted to have the corresponding image displayed with the determined parameter. Another embodiment further comprises means for receiving information relating to an event, such as a new event, from an external supplier, the controlling means being adapted to control the monitor/display to display an image relating to the event.

Also, an embodiment further comprises means for determining a source of at least one event and determining a parameter for the corresponding image based on the determined source, and wherein the controlling means is adapted to have the corresponding image displayed with the determined parameter.

As mentioned above, different sources, externally fed events, different parameters etc. may be illustrated by providing the images at different general directions.

Yet another aspect of the invention relates to a system for presenting visual information relating to one or more available events to a user, the system comprising:
a display or monitor having a display/monitor surface,
first receiving means for receiving, holding or accessing, for each of a first group of the available events, an image relating thereto,
means for providing events to a user and for determining, at a point in time, information relating to a first number of events provided to the user at previous points in time and determining, for one or more of the previously provided events, a parameter relating to a number of times the event or similar events has/have been provided,
means for selecting a second number of events from the first number of events, the selection being based on the parameters determined, and
means for controlling the monitor/display to display the images of the second number of events on the display/monitor, each image moving along a predetermined path over the display/monitor surface.

In one embodiment, the controlling means are adapted to have images move along intersecting paths and determine which image is not displayed at the intersection.

In another embodiment, the controlling means are adapted to determine, for at least one event, a size of the image and controlling the monitor/display to display the image with the determined size. Then, the controlling means may be adapted to reduce the image over time.

In yet another embodiment, the system further comprises means for receiving information relating to an event, such as a new event, from an external supplier, the controlling means being adapted to control the monitor/display to display an image relating to the event.

Also, the system may further comprise means for determining a relevance of at least one event as well as a corresponding parameter of the image and forward this parameter to the controlling means which is adapted to have the corresponding image displayed with the determined parameter.

In addition, an embodiment further comprises means for determining a source of at least one event and determining a parameter for the corresponding image based on the determined source, and wherein the controlling means is adapted to have the corresponding image displayed with the determined parameter.

Again, different general directions may be used.

In a general embodiment, the system further comprises means for a user to identify an image and a corresponding event, and means for providing the event to the user. Thus, the system may comprise or be connected to speakers and/or a larger display/monitor, such as a TV in order to be able to provide audio and/or video information or files.

In one embodiment, the system further comprises means for identifying one or more events related to the provided event, the controlling means being adapted to control the monitor/display to display images relating to the identified events. Such identifying means may use any parameter and search strategy related to the provided event and may search in all available events, locally as well as remotely.

In another embodiment, the system further comprises means for a user to identify an image and a corresponding event, the controlling means being adapted to control the display/monitor to provide additional information relating to the event to the user while displaying images of other events on the display/monitor. This additional information may be all of or parts of the event, such as a part of or all of an audio track or a part of visual information. This visual information may be provided on the display/monitor or on a separate monitor/display. This additional information may simply be an enlargement of the image on the display/monitor or may be additional information, such as other parameters or information relating to the event.

Naturally, if the display/monitor is used for displaying this additional information, it may be allowed to also provide other images at the same time, and it may be decided whether such images may intersect/overlap this information or whether they must only move in other parts of the display/monitor area.

In general, the identifying means may be any type of means adapted to be used to identify an image. One type of such means are means identifying a current position of an image, such as a when the display/monitor is a touch screen. Alternatively, a mouse, joy stick or other position identifying element may be used.

Also, means for entering other information allowing the system to identify an image may be used, such as means for receiving and interpreting oral instructions or a keyboard may be used for receiving information allowing the system to identify a parameter of the event or image, such as an identity of an author, artist, composer, actor, title, description of the event/image or the like. On the basis of such information, the pertaining event or image may be identified.

In the following, preferred embodiments of the invention will be described with reference to the drawing, wherein:

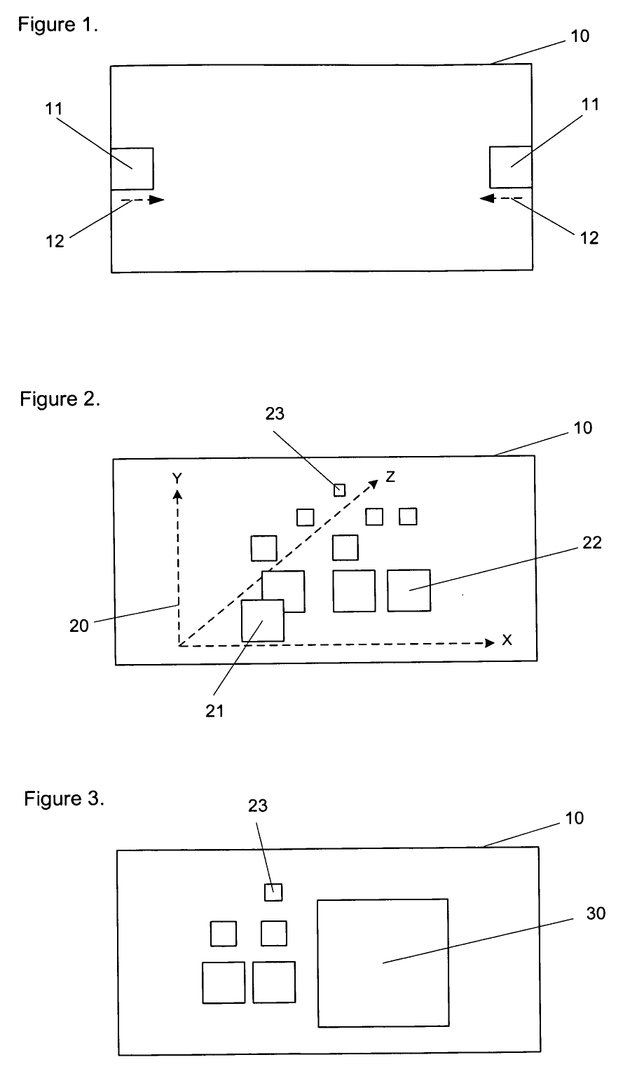

FIG. 1 illustrates a display/monitor with two images,

FIG. 2 illustrates three-dimensional positioning of images,

FIG. 3 illustrates additional information being provided,

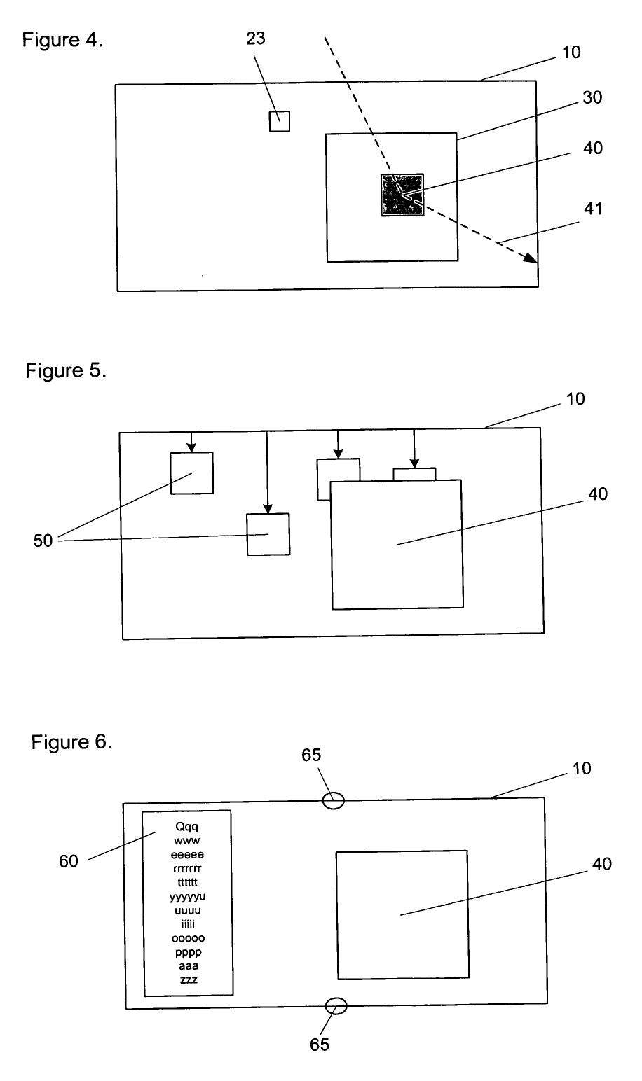

FIG. 4 illustrates alternative paths for images,

FIG. 5 illustrates further paths for images,

FIG. 6 illustrates the providing of additional information, and

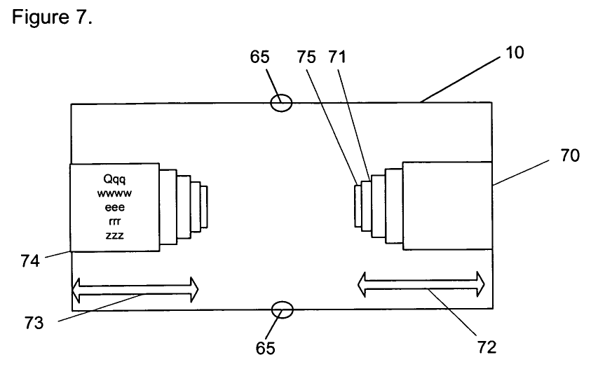

FIG. 7 illustrates supplementary navigation controls.

In general, the present embodiments may be used in or be a part of a media player, a media centre, a TV, a DVD player, a computer or any other type of element having access to or storing events and having a display 10.

In the present embodiment, the events may be audio, video, images, movies, songs, pictures, broadcast TV/sat programme, podcast, live show of any kind, any type of music (radio/video, live, or recorded), web browsing, viewing images/pictures/photos, activities (playing games, browsing, exercising, sports, communicating with others in any manner, such as texting/SMS and/or e-mail), or the like.

Visual information, or objects, is/are provided for available events. Even though this may be any visual information, it should remind the user of the actual event. Thus, an object may be the cover of an album or a movie, or in the situation of an image or picture, the image or picture itself. An event may also be a group of events, such as a whole album or all images/pictures from a given event, such as a holiday. In that situation, the object provided may be representative for all events in the group of events.

The player comprises means (not illustrated) adapted to store or gain access to the events. All of or some of the events may be stored in or on the apparatus, such as in the electronics (not illustrated), such as in the form of a RAM, ROM, PROM, EPROM, EEPROM, Flash, disc, card (SD, miniSD, microSD or the like), hard disc or the like or may be one or more CD-ROM/DVD discs, and/or electrical, magnetic, or optical, or the like, storage.

Alternatively or in addition all of or some of the events may be available thereto from a number of sources, such as from a near-by or internal storage, a remote storage, via a network of any type, or by being streamed from an external source, such as via the WWW or via airborne signals, such as TV or radio signals. This access and communication is handled by the electronics (not illustrated), which comprises or communicates to or via e.g. one or more networking elements, such as NIC's, network adapters, wireless communication devices, routers, switches, Bluetooth elements, IR communication elements, other computers or servers, thin clients, intra nets, the WWW, WANs, LANs or the like.

In addition, the player comprises a controller (not illustrated) which controls the display 10 and determines which objects to display and how to display these.

FIG. 1 illustrates an example of a display screen 10 on a media player. In the so-called Appetizer mode of operation, the objects 11 move into the screen area along a predefined path 12, the criteria for the selection of which events to present screen 10 is made in accordance with predefined filter characteristics.

Examples of filter attributes are, but not limited to:
most used,
last received,
last used,
pushed from an external service.

Naturally, the events between which the search is made may have been identified in an earlier search, so that the ones provided fulfil both the above filter attributes as well as being events only with the artist “Sting” or all events produced in the year 2007.

Objects may enter the screen 10 from both or all sides thereof (or may appear at any other position) and may follow predetermined paths, such as straight paths or curved paths, or may move along paths which are determined in real time. An example of the last type of path is one in which objects may touch and bounce off each other on the screen 10 or may avoid such touching/bouncing by diverting from the planed path.

It is clear that the objects may have any shape and any size, and that the all objects may have the same size.

FIG. 2 illustrates how objects 21, 22, 23 move around on the screen 10, the movement being relative to a three dimensional coordinate system 20.

Thus, depending on e.g. the relevance of an event, the object may be positioned further along the z-axis and as a result thereof be made smaller than objects of more relevant events. Naturally, the relevance may be determined in a number of manners, such as how often the user has experienced the event, how often the user experiences similar events (same artist, type, genre or the like).

EP1826688 illustrates a number of manners of determining relevance of an event. This reference is incorporated by reference.

Alternatively or in addition, a source of the event may be used for determining the position of the pertaining object along the z-axis. Thus, if the event is in the person's own library, it may be more readily available—and available free of charge—whereby its object may be made larger than that of an event available from a remote source, such as the WWW, and which must be paid for.

An alternative to the different sizes of the objects, other parameters, such as shape, speed, frequency of introduction on the screen 10, colour contents or the like, may be used for displaying that different events have different relevance/source or the like.

As mentioned above, two overall directions may be used, such as one or a number of directions all being along the x-axis or closer (angle) to that than the y-axis and vice versa. Naturally, such two directions or groups of directions may be selected and differentiated in any desired manner.

In addition, an object may be moved along the Z-axis (change in size) over time, as it may be assumed that the event's relevance is lower than initially expected as the user does not select the event. Thus, as the information moves over the screen or is re-introduced on the screen 10, it may be positioned further along the Z-axis (fade or be made smaller) than hitherto. Eventually, it may be decided to not provide that object again, as its relevance seems too low.

In an emulation of a 3D universe, this would mean that the image of this event moves also away from the user.

In addition to or alternative to the above differences in size, colour, or the like to illustrate a difference between objects, it may also be decided that certain types of objects follow different paths than other types of objects (such as horizontal vis-à-vis vertical).

One example is to have objects triggered from external events move generally along the Y-axis.

The time for the objects to be present on the screen, and/or the frequency at which the objects are provided, may be configured according to application requirements or may be selected by the user. In addition, the number of objects to be simultaneously present on the screen may be configured according to application requirements or selected by the user.

The criteria for specific objects to be positioned on the screen and the display mode is/are selected according to predefined filter characteristics, which may comprise the determination of the objects:
speed,
layer/plane (x,y,z position),
icon/graphic ID, colour or other properties, and/or
cycle (newest-to-oldest).

FIG. 3 illustrates a situation where one of the objects 21, 22 has been selected by a user.

This selection may be the user indicating the position of the object on the screen 10. If the screen is a touch screen, this may be obtained by simply touching the object's position on the screen 10. Alternatively, the user may use a pointing device, such as a computer mouse, a joy stick or the like. Alternatively, a keyboard or other type of input entering means may be used to identify the particular object either by its position, name, properties (colour, artist, title or the like) or the like.

This object then becomes currently active in a particular focus area 30 of the screen 10. Correspondingly, the object is highlighted, such as enlarged, and may be activated. If the corresponding event is a music file, the object in the area 30 may be the graphical cover or part of the cover, and the activation may have the music file played.

According to the type of event related to the selected object, the graphical information provided in the area 30 and/or the activation or response to the user may differ:
play music and display CD cover,
display photo and optionally play related music,
display video and play related music,
display TV channel in the area 30 and/or on a TV/monitor,
show a DVD file and/or its cover in the area 30 and/or on a TV/monitor,
show a live AV clip in the area 30 and/or on a TV/monitor,
show or provide an AVI file or a Podcast in the area 30 and/or on a TV/monitor,
provide a DAB transmission and show corresponding information in the area 30,
provide another digital source in the area 30 and/or on another media provider (TV, radio, speakers, monitor or the like).

The size of the object presented on the screen may be configured according to application requirements e.g. full size cover, partly cover, full screen, partly screen and alike.

Naturally, it may be desired to provide other objects 23 at the same screen at the same time as the target object in the area 30. These objects 23 may be allowed to enter the area 30 or not.

FIG. 4 illustrates that during playing/providing of an actual object file illustrated in the area 30, external events may trigger new objects 40 to appear on the screen 10. Preferably, such objects are dropping into the screen 10 from the top of the screen 10 and passing along a predefined path 41 before it leaves the screen 10.

During this passage, the object 40 is a candidate to be the current active object, if it is selected by the user. This type of objects may inspire the user to change to other functions and/or domains to explore.

FIG. 5 illustrates the situation where the object 40 has been selected and is provided in the highlighted manner (enlarged).

Then, events related to the selected object 40 are identified and corresponding objects 50 are provided.

Again, the path, size, colour, parameters or the like may relate to the relevance, source or the like of these objects 50.

The relations among the current active object 40 and the new objects may be of any predefined type, and may be among different type of objects like:
artist, composer, event, album, genre, mood etc.,
music file, podcast, type of event (concert), movie, photo etc.

FIG. 6 illustrates how the Player functionality may be supported by control means like button/menus 65 for context- and content navigation, and detailed information on list form 60, the list containing content description of the current channels, tracks and alike. Thus, when an object 40 has been selected, another area of the screen 10 may be reserved for providing additional information relating to the selected event/object. In the situation where the event is a group of events, such as an album, individual events or songs may be provided in the area, where the user then may select the song desired.

FIG. 7 illustrates that the automatic feeding of events may be over-ridden and how the Browser functionality may be supported by manually operatable control means like button/menus 65,72,73 for context- and content navigation, and detailed information on list form 74, the list containing content description of the current channels, tracks and the like.

The control means 72 may be used to single scroll through the collection of object files, from the current one 70 to the end of the stack of objects 75, and visa versa from the end 75 and to the beginning 70.

The control means 73 may be used to single scroll through the list content related to the object files 74. This scroll is synchronized with the operation of the scroll of the source files 70, so that list information complies with the actual object file in focus.

Alternative scroll modes may be applied like: scroll all, scroll alphabetic, scroll genre, scroll artist etc.

1. A method of presenting visual information relating to one or more available events to a user, the method comprising:
1. providing a display or monitor having a display/monitor surface,
2. providing, for each of a first group of available events, an image relating thereto,
3. displaying the images of one or more events of the first group on the display/monitor, each image moving along a predetermined path having a first general direction over the display/monitor surface,
4. providing information relating to a second group of events, the information comprising an image relating to each event of the second group, and
5. displaying the images of one or more events of the second group on the display/monitor, each image moving along a predetermined path having a second general direction over the display/monitor surface, the second general direction being different from the first general direction.

2. A method according to claim 1, wherein step 5 comprises receiving information relating to an event, not forming part of the first group, from an external supplier, the information comprising information relating to a new image, step 5 further comprising displaying the new image on the display/monitor along a predetermined path having the second general direction.

3. A method according to claim 1, wherein step 4 comprises determining or selecting, from the first group of events, the events of the second group of events, each event of the second group corresponding to a predetermined event.

4. A method according to claim 1, further comprising the step of determining, for at least one event, a relevance thereof and a corresponding parameter of the image and wherein step 3 and/or 5 comprises displaying the image with the determined parameter.

5. A method according to claim 1, further comprising the step of determining a source of an event and determining a parameter for the corresponding image based on the determined source, and wherein step 3 and/or 5 comprises displaying the corresponding image with the determined parameter.

6. A method of presenting visual information relating to one or more available events to a user, the method comprising:
1. providing a display or monitor having a display/monitor surface,
2. providing, for each of a first group of available events, an image relating thereto,
3. determining, for at each event of the first group, an initial size of the corresponding image,
4. displaying the images of one or more events of the first group on the display/monitor, each image moving along a predetermined path over the display/monitor surface,
wherein step 4 comprises initially displaying the one or more images with the initial sizes, the sizes of the images being reduced over time.

7. A method according to claim 6, further comprising the step of determining, for at least one event, a relevance thereof and a corresponding parameter of the image and wherein step 4 comprises displaying the image with the determined parameter.

8. A method according to claim 6, further comprising the step of receiving information relating to an event from an external supplier, step 4 comprising displaying an image relating to the event on the display/monitor.

9. A method according to claim 6, further comprising the step of determining a source of an event and determining a parameter for the corresponding image based on the determined source, and wherein step 4 comprises displaying the corresponding image with the determined parameter.

10. A method of presenting visual information relating to one or more available events to a user, the method comprising:
1. providing a display or monitor having a display/monitor surface,
2. providing, for each of a first group of available events, an image relating thereto,
3. determining, at a point in time, information relating to a first number of events provided to the user at previous points in time and determining, for one or more of the previously provided events, a parameter relating to a number of times the event or similar events have been provided,
4. selecting a second number of events from the first number of events, the selection being based on the parameters determined,
5. displaying the images of the second number of events on the display/monitor, each image moving along a predetermined path over the display/monitor surface.

11. A method according to claim 10, wherein step 5 comprises having images moving along intersecting paths and comprising a step of determining which image is not displayed at the intersection.

12. A method according to claim 10, wherein step 5 comprises determining, for at least one event, a size of the image and displaying the image with the determined size.

13. A method according to claim 12, wherein the size of an image is reduced over time.

14. A method according to claim 10, further comprising the step of receiving information relating to an (new) event from an external supplier, step 5 comprising displaying an image relating to the (new) event on the display/monitor.

15. A method according to claim 10, wherein step 5 comprises determining, for at least one event, a relevance thereof and a corresponding parameter of the image and wherein the displaying step comprises displaying the image with the determined parameter.

16. A method according to claim 10, further comprising the step of determining a source of an event and determining a parameter for the corresponding image based on the determined source, and wherein step 5 comprises displaying the corresponding image with the determined parameter.

17. A method according to claim 10, further comprising the step of a user identifying an image and a corresponding event, and providing the event to the user.

18. A method according to claim 17, further comprising the step of identifying one or more events related to the provided event and displaying on the display/monitor images relating to the identified events.

19. A method according to claim 10, further comprising the step of a user identifying an image and a corresponding event, and providing additional information relating to the event to the user while displaying images of other events on the display/monitor.

20. A system for presenting visual information relating to one or more available events to a user, the system comprising:
a display or monitor having a display/monitor surface,
first receiving means for receiving, holding or accessing, for each of a first group of the available events, an image relating thereto,
means for controlling the monitor/display to display the images of the first group on the display/monitor, each image moving along a predetermined path having a first general direction over the display/monitor surface, and
second receiving means for receiving, holding or accessing, for a second group of the available events, an image relating thereto,
the controlling means being adapted to control the monitor/display to display the images of the second group on the display/monitor, each image of the second group moving along a predetermined path having a second general direction over the display/monitor surface, the second general direction being different from the first general direction.

21. A system according to claim 20, wherein the second receiving means are adapted to receive information relating to an event from an external supplier, the controlling means being adapted to control the monitor/display to display an image relating to the event along a predetermined path having the second general direction.

22. A system according to claim 20, wherein the second receiving means are adapted to select the second group of events from the first group of events, each event of the second group corresponding to a predetermined event.

23. A system according to claim 20, further comprising means for determining a relevance of at least one event as well as a corresponding parameter of the image and forward this parameter to the controlling means which is adapted to have the corresponding image displayed with the determined parameter.

24. A system according to claim 20, further comprising means for determining a source of at least one event and determining a parameter for the corresponding image based on the determined source, and wherein the controlling means is adapted to have the corresponding image displayed with the determined parameter.

25. A system for presenting visual information relating to one or more available events to a user, the system comprising:
a display or monitor having a display/monitor surface,
first means for receiving, holding or accessing, for each of a first group of the available events, an image relating thereto and means for determining, for at each event of the first group, an initial size of the corresponding image,
means for controlling the monitor/display to display the images of the first group on the display/monitor so that each image moves along a predetermined path, each image initially has its initial size and the size of each image is reduced in time.

26. A system according to claim 25, further comprising means for determining a relevance of at least one event as well as a corresponding parameter of the image and forward this parameter to the controlling means which is adapted to have the corresponding image displayed with the determined parameter.

27. A system according to claim 25, further comprising means for receiving information relating to an event from an external supplier, the controlling means being adapted to control the monitor/display to display an image relating to the event.

28. A system according to claim 25, further comprising means for determining a source of at least one event and determining a parameter for the corresponding image based on the determined source, and wherein the controlling means is adapted to have the corresponding image displayed with the determined parameter.

29. A system for presenting visual information relating to one or more available events to a user, the system comprising:
a display or monitor having a display/monitor surface,
first receiving means for receiving, holding or accessing, for each of a first group of the available events, an image relating thereto,
means for providing events to a user and for determining, at a point in time, information relating to a first number of events provided to the user at previous points in time and determining, for one or more of the previously provided events, a parameter relating to a number of times the event or similar events have been provided,
means for selecting a second number of events from the first number of events, the selection being based on the parameters determined, and
means for controlling the monitor/display to display the images of the second number of events on the display/monitor, each image moving along a predetermined path over the display/monitor surface.

30. A system according to claim 29, wherein the controlling means are adapted to have images move along intersecting paths and determine which image is not displayed at the intersection.

31. A system according to claim 29, wherein the controlling means are adapted to determine, for at least one event, a size of the image and controlling the monitor/display to display the image with the determined size.

32. A system according to claim 31, wherein the controlling means are adapted to reduce the size of an image over time.

33. A system according to claim 29, further comprising means for receiving information relating to an event from an external supplier, the controlling means being adapted to control the monitor/display to display an image relating to the event.

34. A system according to claim 29, further comprising means for determining a relevance of at least one event as well as a corresponding parameter of the image and forward this parameter to the controlling means which is adapted to have the corresponding image displayed with the determined parameter.

35. A system according to claim 29, further comprising means for determining a source of at least one event and determining a parameter for the corresponding image based on the determined source, and wherein the controlling means is adapted to have the corresponding image displayed with the determined parameter.

36. A system according to claim 29, further comprising means for a user to identify an image and a corresponding event, and means for providing the event to the user.

37. A system according to claim 36, further comprising means for identifying one or more events related to the provided event, the controlling means being adapted to control the monitor/display to display images relating to the identified events.

38. A system according to claim 29, further comprising means for a user to identify an image and a corresponding event, the controlling means being adapted to control the display/monitor to provide additional information relating to the event to the user while displaying images of other events on the display/monitor.
